(19) United States
(12) Patent Application Publication
(10) Pub. No.: US 2023/0044241 A1
(43) Pub. Date: Feb. 9, 2023

(54) CollectiveBuying.io

(71) Applicant: David Arnold Beard, Hanover, MD (US)

(72) Inventor: David Arnold Beard, Hanover, MD (US)

(21) Appl. No.: 17/819,636

(22) Filed: Sep. 14, 2022

(51) Int. Cl. G06Q 30/02; G06Q 30/06

(52) U.S. Cl. CPC G06Q 30/0207; G06Q 30/0609

(57) ABSTRACT

Under collective buying, quantity discounts are offered based on buyers aggregated purchasing quantity instead of individual purchasing quantities. As the price decreases with the total amount, buyers have positive externalities that allow them to obtain lower prices than they would otherwise be able to get individually (Chen and Roma 2011, 181).

Although collective buying has been widely used for business-to-business and business-to-consumer transactions (Chen and Roma 2011, 181), there is an underlying problem with the use of discount vouchers as they can call into question the reliability that the minimum number of buyers will make the purchase. In practice, once discount vouchers have been delivered, the minimum order quantity set by the seller is significantly greater than the aggregated quantity purchased.

CollectiveBuying.io (CB) discovered new processes that are unique and valuable improvements to the traditional collective buying model. CB’s techniques solve existing problems, can adapt to find fast solutions, and can prevent future problems. In the problem mentioned previously, CB’s cryptographic methods provide a means by which the buyers demonstrate a Commitment-to-Purchase to increase the aggregated quantity purchased. In addition, CB’s improved model operates on blockchain cryptography to provide buyers with the additional benefits of authentication, authorization, anonymization, and accountability.

CB is a method for use in the practice, administration, and management of economic models; the processing of financial data; and when determining the exchange of goods or services. Furthermore, CB is a model, a design, a process, and an improvement for data subject to authentication, authorization, anonymization, and other security through techniques such as digital rights management, encryption, tokenization, biometrics, device profiling, localization, timing, risk or fraud assessment, distributed ledger transactions, cryptocurrency transactions, software licensing, and voting (United States Patent and Trademark Office [USPTO]).

### BACKGROUND OF THE INVENTION

Under collective buying, quantity discounts are offered based on buyers aggregated purchasing quantity instead of individual purchasing quantities. As the price decreases with the total amount, buyers have positive externalities that allow them to obtain lower prices than they would otherwise be able to get individually (Chen and Roma 2011, 181). Although collective buying has been widely used for business-to-business and business-to-consumer transactions (Chen and Roma 2011, 181), there is an underlying problem with the use of discount vouchers as they can call into question the reliability that the minimum number of buyers will make the purchase. In practice, once discount vouchers have been delivered, the minimum order quantity set by the seller is significantly greater than the aggregated quantity purchased.

### SUMMARY OF THE INVENTION

CollectiveBuying.io (CB) discovered new processes that are unique and valuable improvements to the traditional collective buying model. CB’s techniques solve existing problems, can adapt to find fast solutions, and can prevent future problems. In the problem mentioned previously, CB’s cryptographic methods provide a means by which the buyers demonstrate a Commitment-to-Purchase to increase the aggregated quantity purchased.

### BRIEF DESCRIPTION OF DRAWINGS

FIG. 1 is a functional flow diagram, the new process that is unique and that is a valuable improvement is titled “MINIMUM # OF PEOPLE AGREE TO BUY”. FIG. 2 is an activity diagram, the new process that is unique and that is a valuable improvement is bottom-centered in the diagram. FIG. 3 is a behavior diagram, the new process that is unique and that is a valuable improvement is an event titled “Buyer owns a Digital Certificate of Authenticity”.

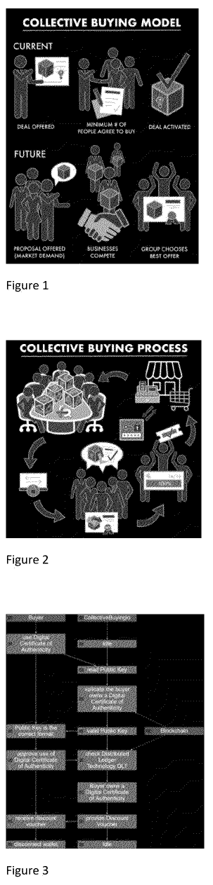

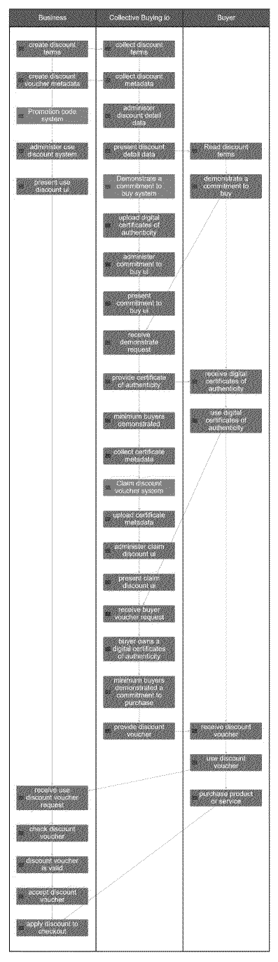

### DETAILED DESCRIPTION OF THE INVENTION

The new process that is unique and that is a valuable improvement to traditional collective buying, also known as group buying, is the method termed “demonstrating a commitment-to-purchase.” The use of this method improves aggregated quantity purchased. In traditional collective buying and group buying, the minimum order quantity set by the seller is significantly greater than the aggregated quantity purchased. The seller bases the terms of the deal on the minimum order quantity. Demonstrating a commitment-to-purchase is a commitment to purchase the product, the demonstration reassures the seller that the minimum order quantity will also be quantity purchased. Example #1, the seller will offer a discounted price if 10,000 buyers purchase the product. The discount is not activated until 10,000 buyers have demonstrated a commitment-to-purchase. Example #2, the 50,000 buyers demonstrated a commitment-to-purchase product type A. Seller X offers product type A at a 40% discounted price. Seller Y offers product type A at a 50% discounted price. The 50,000 buyers that demonstrated a commitment-to-purchase select Seller Y’s offer.

1. A new process that is a unique and a valuable improvement to the traditional collective buying model, also known as, group buying. The new process uses a new method for order quantity, comprising:
The buyer demonstrating a commitment to purchase before the seller issues a deal. Demonstrating a commitment to purchase is a commitment to purchase the product or service.
The quantity of buyers that demonstrated a commitment to purchase is directly related to the order quantity in the deal. The deal is offered based on the quantity of buyers that have demonstrated a commitment to purchase.
